(19) United States
(12) Patent Application Publication
(10) Pub. No.: US 2026/0024129 A1
(43) Pub. Date: Jan. 22, 2026

(54) SYSTEM AND METHOD FOR IMPLEMENTING MULTI-LOCATION AND MULTI-CART SWITCHING ON A USER ACCOUNT

(71) Applicant: Shamrock Foods Company, Phoenix, AZ (US)

(72) Inventors: Matthew Thompson, Phoenix, AZ (US); Alexander Sneeringer, Gilbert, AZ (US); Jason Bowman, Chicago, IL (US); Leila Arab, Chicago, IL (US)

(21) Appl. No.: 19/272,126

(22) Filed: Jul. 17, 2025

Related U.S. Application Data
(60) Provisional application No. 63/673,321, filed on Jul. 19, 2024.

(51) Int. Cl. G06Q 30/0601

(52) U.S. Cl. CPC G06Q 30/06333; G06Q 30/0641

(57) ABSTRACT

Methods are described herein for implementing multi-location switching in an online marketplace. A system may receive, via a communication interface, a first request to access a user account that may be associated with one or more sub-accounts. The system may validate the first request and generate a first user interface based on the user account. The first user interface may include visual representations of data dependent on the user account. The system may present, via the communication interface, the first user interface. The system may receive a second request to access a first sub-account of the one or more sub-accounts. In response, the system may update the first user interface based on the first sub-account to yield a second user interface. The second user interface may include updated visual representations of data dependent on the first sub-account. The system may present the second user interface.

### CROSS REFERENCE TO RELATED APPLICATIONS

This application claims priority to and the benefit of U.S. Provisional Application No. 63/673,321, filed Jul. 19, 2024, titled “SYSTEM AND METHOD FOR IMPLEMENTING MULTI-LOCATION SWITCHING ON A USER ACCOUNT,” the disclosure of which is hereby incorporated by reference in its entirety and for all purposes.

### TECHNICAL FIELD

This disclosure relates generally to an online order platform. More specifically, this disclosure relates to a multi-location order platform configured to facilitate seamless transition between one or more sub-accounts and/or one or more mini-carts associated with the multi-location order platform.

### BACKGROUND

The development of online shopping technology has seen significant advancements in recent years, driven by the increasing penetration of the internet, the proliferation of smart devices, and the evolving expectations of consumers. Initially, online shopping platforms were simple, text-based systems that allowed users to browse product listings and make purchases via basic forms. These early systems were often cumbersome and lacked the user-friendly interfaces and advanced functionalities that modern consumers expect. However, the rapid advancement in web technologies, including HTML5, CSS3, and JavaScript, has enabled the creation of highly interactive and responsive e-commerce websites. Additionally, the integration of secure payment gateways, real-time inventory management, and sophisticated recommendation algorithms has transformed online shopping into a seamless and personalized experience.

In recent years, the rise of mobile commerce (m-commerce) has further revolutionized the online shopping landscape. With the widespread adoption of smartphones and tablets, consumers can now shop from anywhere, at any time, leading to a surge in mobile-optimized e-commerce platforms and applications. Innovations such as augmented reality (AR) and virtual reality (VR) have also begun to play a role in online shopping, offering immersive experiences that allow customers to virtually try on products or visualize them in their homes. Furthermore, the application of artificial intelligence (AI) and machine learning (ML) in areas like customer service (through chatbots and virtual assistants), predictive analytics, and personalized marketing has enhanced the efficiency and effectiveness of online shopping, making it more intuitive and tailored to individual preferences. These technological advancements have collectively contributed to the rapid growth and evolution of the online shopping industry, creating new opportunities and challenges for businesses and consumers alike.

However, a need still exists in the art for a functional method for managing more than one shopping account within a single e-commerce website. Some consumers are associated with one or more institutions, enterprises, locations, businesses, and the like, and require different settings, shipping addresses, payment information, etc. for each of them. Currently, there is no streamlined and efficient solution for facilitating a seamless transition between sub-accounts associated with a single user account, thereby allowing a user to add items to carts, complete a checkout process, generate an order guide, view recent orders, and the like, for different sub-accounts (e.g., business, locations, etc.) without a cumbersome and burdensome process.

### SUMMARY

Methods are described herein for implementing multi-location switching in an online marketplace. In one aspect, a system may receive, via the communication interface, a first request to access a user account, where the user account is associated with one or more sub-accounts. The system may validate the first request according to one or more security protocols and generate a first user interface based on the user account. The first user interface may include visual representations of data dependent on the user account. The system may then present, via the communication interface, the first user interface. Additionally, the system may then receive a second request to access a first sub-account of the one or more sub-accounts. In response, the system may update the first user interface based on the first sub-account to yield a second user interface. The second user interface may include updated visual representations of data dependent on the first sub-account. The system may present the second user interface.

In another aspect, the method may further include receiving, via the second user interface of the communication interface, a third request to maintain a first digital object. The first digital object is associated with the first sub-account. The system may receive, via the communication interface, user input indicating that the first digital object should be updated to include a first resource. Then, the system may update the first digital object to include the first resource.

In another aspect, the first digital object may include at least two digital sub-objects associated with respective resources. The method may further include receiving, via the second user interface of the communication interface, a fourth request to maintain a digital sub-object of the at least two digital sub-objects, wherein the digital sub-object is associated with the first digital object and the first sub-account. The system may receive, via the communication interface, user input indicating that the digital sub-object should be updated to include a second resource. The system may update the digital sub-object to include the second resource.

In another aspect, the method may further include receiving, via the communication interface, a transaction request to complete a transaction associated with the digital sub-object.

In another aspect, the method may further include receiving, via the communication interface, a fifth request to access a second sub-account of the one or more sub-accounts. In response, the system may update the second user interface based on second sub-account to yield a third user interface and present the third user interface. The third user interface includes updated visual representations of data dependent on the second sub-account.

In another aspect, the method may further include receiving, via the third user interface of the communication interface, a sixth request to maintain a second digital object. The second digital object may be associated with the second sub-account. The method may further include receiving, via the communication interface, user input indicating that the second digital object should be updated to include a second resource. The method may also update the second digital object to include the second resource.

In another aspect, the one or more sub-accounts may be associated with a respective digital object accessible via a user interface. In another aspect, the one or more security protocols may include verifying a user identifier has permission to access the one or more sub-accounts.

In another aspect, the method may further include receiving, via the communication interface, a transaction request to complete a transaction associated with a digital object of the first sub-account. In another aspect, the method may further include completing the transaction associated with the digital object of the first sub-account. The system may transmit the transaction to one or more remote servers for fulfillment, where the transaction includes data associated with the digital object and the first sub-account. When the transaction is received by the one or more remote servers, the one or more remote servers may begin servicing the transaction.

In another aspect, the method may further include sending a notification to the user account, where the notification includes an indication that the transaction may be modified. In another aspect, the notification may include an indication that the one or more remote servers have completed servicing the transaction and the transaction can no longer be modified. Other technical features may be readily apparent to one skilled in the art from the following figures, descriptions, and claims.

Systems are described herein for implementing multi-location switching in an online marketplace. The systems may comprise one or more processors and a memory storing instructions that, as a result of being executed by the one or more processors, cause the system to perform any of the aforementioned methods.

Non-transitory computer-readable storage media are described herein that store instructions therein that, as a result of being executed by one or more processors, cause the one or more processors to perform the any of the aforementioned methods.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example network environment that may implement various systems and methods according to some aspects of the present disclosure.

FIG. 2 illustrates an example block diagram of a multi-location order platform according to some aspects of the present disclosure.

FIG. 3 illustrates an example block diagram of a dashboard engine of the multi-location order platform according to some aspects of the present disclosure.

FIG. 4 illustrates an example of a user interface of the multi-location order platform according to some aspects of the present disclosure.

FIG. 5 illustrates an example of a recent order and/or order history functionality the user interface of the multi-location order platform according to some aspects of the present disclosure.

FIG. 6 illustrates an example of an order guide functionality of the user interface of the multi-location order platform according to some aspects of the present disclosure.

FIG. 7A, FIG. 7B, FIG. 7C, and FIG. 7D illustrates an example of a multi-location switching functionality of the user interface of the multi-location order platform according to some aspects of the present disclosure.

FIG. 8A illustrates an example of the user interface of the multi-location order platform according to some aspects of the present disclosure.

FIG. 8B illustrates an example of the user interface of the multi-location order platform according to some aspects of the present disclosure.

FIG. 9A and FIG. 9B illustrate an example of a user interface of a virtual cart associated with a sub-account that includes two or more sub-carts according to some aspects of the present disclosure

FIG. 10 illustrates an example user interface of a multi-location order platform according to some aspects of the present disclosure.

FIG. 11 illustrates an example flowchart for implementing multi-location switching in an online marketplace according to some aspects of the present disclosure.

FIG. 12 illustrates an example computing device capable of executing the multi-location order platform and any other associated components according to some aspects of the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure describes a multi-location order platform accessible to one or more user accounts for searching, ordering, and maintaining an updated list of one or more resources associated with one or more locations (e.g., sub-accounts associated with a user account). In some examples, a user associated with a user account may initiate a log-in (or another identity verification measure, such as a multi-factor authorization, an email verification, facial/fingerprint recognition, security question, IP address confirmation, any combination thereof, or the like) at a website associated with the multi-location order platform. In some examples, the multi-location order platform may be accessible via the Internet as a website, or may be downloaded onto a user device and accessed locally. In some other examples, the multi-location order platform may be stored at a cloud provider and the user device may request to initiate an instance of the multi-location platform.

Upon log-in by the user device, the multi-location order platform may query a secured database associated with the multi-location order platform that may store data regarding access permissions of a user account associated with the user device. The access permissions may be generated by policy, one or more other user accounts, an administrative account, a managing account, any combination thereof, or the like. The access permission may dictate which, if any, sub-accounts the user account may access. The sub-accounts of the user account may be associated with businesses, restaurants, individuals, entities, locations, non-profits/charities, organizations, personal homes, any combination thereof, or the like. For example, a managing account associated with Sub-Account A may allocate the user account as an “authorized user,” (e.g., by name, email, phone number, etc.) thereby permitting the user account to access Sub-Account A. In some examples, the user account may setup a new sub-account. In such examples, the user account would, by default, become the managing account associated with the new sub-account. A

The user device may, via a communication interface associated with the user device (e.g., a screen, a monitor, a television, a touchscreen display, any combination thereof, or the like) display a user interface upon login of the user account. The user interface may include one or more interactive displays, lists, options, any combination thereof, or the like, configured to facilitate the assembly, ordering, and maintenance of one or more carts associated with one or more sub-accounts. In some examples, the user interface may be associated with a first sub-account. The first sub-account may be selected based on recent activity of the user account (e.g., the first sub-account was the sub-account with the most recent activity from the user account), frequency (e.g., the user account accesses the first sub-account the most often), a default policy (e.g., the first sub-account is the first in an alphabetical list of associated sub-accounts, the first sub-account is the only sub-account associated with the user account, user account settings dictate the first sub-account as the default, etc.), location (e.g., the first sub-account is associated with a geographic location that is closest to the current location of the user device), any combination thereof, or the like.

The user interface may be generated by one or more processors associated with the multi-location order platform based on the first sub-account. For example, the one or more processors may generate media and/or resources to be displayed on the user interface according to data associated with the first sub-account. The data associated with the first sub-account may include, but is not limited to, a name (e.g., an individual, a business, “D.B.A.,” an enterprise, a school, a non-profit, a receiving individual/office, a building, etc.), a nickname associated with the sub-account (e.g., “Mom's House,” “Lizzie's College Dorm,” “Restaurant A, North Location,” “Jim's Apartment,” “East Warehouse,” etc.), geographic location, address (e.g., business, home address, mailing address, P.O. Box, etc.), operational hours, managing accounts/permitted accounts, associated cuisines (e.g., Mediterranean, Chinese, Italian, Homestyle, Breakfast/Brunch, etc.), budgets, order history, any combination thereof, or the like. For example, the resources displayed via the user interface may vary in price, availability, shipping times, etc. based on the geographic location associated with the first sub-account. The user interface may also include display options dependent on the data associated with the first sub-account, including color scheme of the user interface, language options, format of the user interface, currency, any combination thereof, or the like.

In some examples, the user interface may include a virtual cart accessible by interacting with a reference to the virtual cart within the user interface (e.g., a graphic icon, a clickable link, etc.). The virtual cart may include one or more resources that the user account has elected to include in the virtual cart within the user interface (e.g., the user account may add “French fries,” “bagels,” “plates,” etc. to the virtual cart in association with the first sub-account). In some examples, a sub-account may be associated with a virtual cart. For example, the virtual cart may be associated with the first sub-account. The one or more resources (and one or more attributes associated with the one or more resources, such as quantity, pricing, availability, etc.) stored within the virtual cart may be associated with the first sub-account. In some examples, the virtual cart may be shared between one or more user accounts, and may be updated in real-time as a user account of the one or more user accounts adds a resource. The virtual cart may also include a multi-location switching option, whereby the user account may opt to switch from the first sub-account to a second sub-account. When the user account switches to another sub-account, the user interface, virtual cart, etc. may be updated according to data associated with the other sub-account. In some examples, the multi-location switching option may not be included within the virtual cart, and may be accessible via another interactive element within the user interface.

In some examples, a virtual cart associated with a sub-account may include two or more sub-carts. The two or more sub-carts may include some or all of the characteristics of the virtual cart (e.g., storing resources, association with the sub-account, association with the user account, association with a particular entity/address/payment method, etc.). The two or more sub-carts may be accessible when the user interface is configured according to the sub-account. In some examples, the user account may add a sub-cart, remove a sub-cart, or edit a sub-cart. The two or more sub-carts may be associated with a particular day, an authorized user associated with the sub-account, a particular event, any combination thereof, or the like.

The multi-location switching option may include a display of a list of one or more sub-accounts associated with the user account, which may include the first sub-account and the second sub-account. The multi-location switching option may also display an indication of the current sub-account (e.g., the sub-account that is presently being utilized by the multi-location order platform to generate the user interface and/or the sub-account that is presently associated with the virtual cart that includes one or more resources). The indication may be a checkmark, a box, a difference in text (e.g., bold or italicized font choices), a difference in background color, a text indicator (e.g., “selected” is included next to the present sub-account), any combination thereof, or the like.

The user device may transmit input to the multi-location order platform from an input device (e.g., a keyboard, a mouse, a touch on a touchscreen, etc.) indicating a selection of the second sub-account. The user interface may update according to data associated with the second sub-account (e.g., geographic location, language, order history, etc.). This may include altering one or more resources available within the multi-location order platform (e.g., cost, shipping time, availability, etc.). For example, a first resource available for the first sub-account may not be available for the second sub-account due to shipping restrictions. Thus, the first resource may not be capable of adding to a virtual cart associated with the second sub-account.

When the location is switched, the multi-location order platform may store data associated with the user interface of the first sub-account. For example, the multi-location order platform may maintain storage of Internet cookies, search histories, the virtual cart associated with the first sub-account, browsing histories, any combination thereof, or the like. Using this data associated with the user interface of the first sub-account, the multi-location order platform may maintain the user interface, even if the user interface is not currently being displayed on the user device. Therefore, if/when the user account opts to switch to the first sub-account after switching to another sub-account (e.g., the second sub-account), the user interface associated with the first sub-account may remain unchanged from how the user account left the user interface associated with the first sub-account (e.g., the virtual cart is the same, the search history is the same, preferences of the sub-account are the same, etc.). In some examples, the stored data may be used to maintain a seamless transition between user interfaces (e.g., when switching sub-accounts while browsing, the multi-location order platform keeps the user account on the same webpage within the multi-location order platform when the user interface is updated). With this capability, the user account may be able to seamlessly transition from one sub-account to another sub-account mid-ordering process, without the inconvenience of having to fully complete a “check out” process before switching to another sub-account.

In some examples, the multi-location order platform may maintain some data between user interfaces, depending on preferences of the user account (e.g., configured in settings associated with the user account, either by the user or by the multi-location order platform). When the user account switches from a user interface associated with the first sub-account to a user interface associated with the second sub-account, the multi-location order platform may initiate the user interface associated with the second sub-account on a substantially similar webpage, as opposed to redirecting the user account to a “home” or “default” page of the multi-location order platform. For example, if a user account is viewing a first resource on a webpage associated with the multi-location order platform, and opts to switch to another sub-account while viewing the first resource on the webpage, the user interface associated with the other sub-account may load and initially direct the user account to a substantially similar, if not the same, webpage of the first resource. As an illustrative example, a user account can be viewing “everything bagels” on the multi-location order platform (with data associated with the first sub-account, such as pricing and shipping), switch sub-accounts to the second sub-account, then be redirected to a webpage viewing “everything bagels” on the multi-location order platform (with data associated with the second sub-account, such as pricing and shipping).

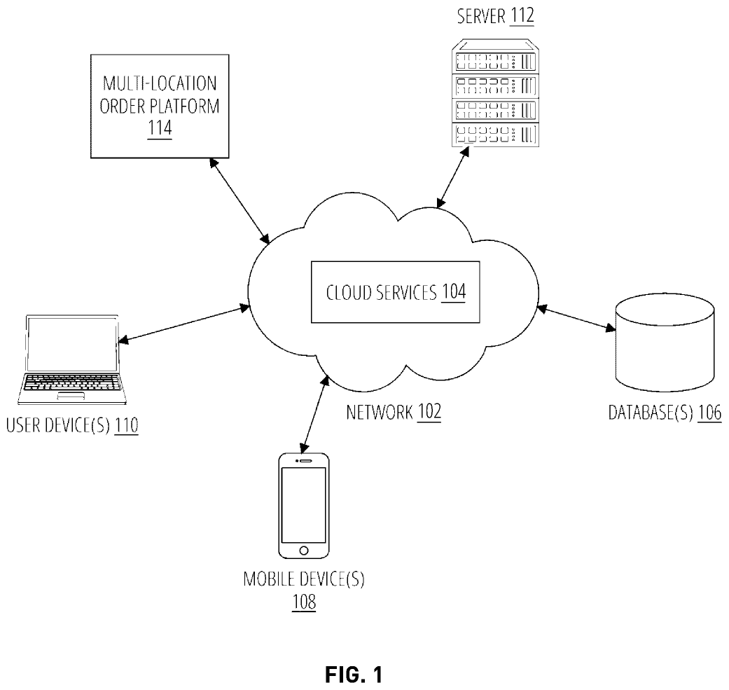

FIG. 1 illustrates an example network environment for implementing the various systems and methods, as described herein. As depicted, network 102 is used by one or more computing or data storage devices for implementing the systems and methods for a multi-location order platform. In one implementation, various components of multi-location order platform 114, one or more user device(s) s 110, one or more database(s) 106, other network components or computing devices, and/or one or more user mobile device(s) 108 described herein are communicatively connected to the network 102. Examples of the user device(s) 110 include a terminal, personal computer, a tablet, a mobile computer, a workstation, and/or the like. Examples of mobile device(s) 108 may include a smart-phone or other type of mobile computing device.

Server 112 may, in some instances, host the system. In one implementation, server 112 also hosts a website or an application that users may visit to access the network environment, including multi-location order platform 114. Server 112 may be one single server, a plurality of servers with each such server being a physical server or a virtual machine, or a collection of both physical servers and virtual machines. In another implementation, a cloud hosts one or more components of the system. For example, cloud services 104 may be offered by network 102 to host any aspect of the operation and/or component of multi-location order platform 114, such as storage capabilities, compute capabilities, networking capabilities, and the like. Cloud services 104 may host a portion or all of the varied components of multi-location order platform 114 to provide a cloud-based solution. Multi-location order platform 114, user device(s) 110, server 112, mobile device(s) 108, and other resources connected to network 102 may access one or more additional servers for access to one or more websites, applications, web services interfaces, etc. that are used for multi-location order management.

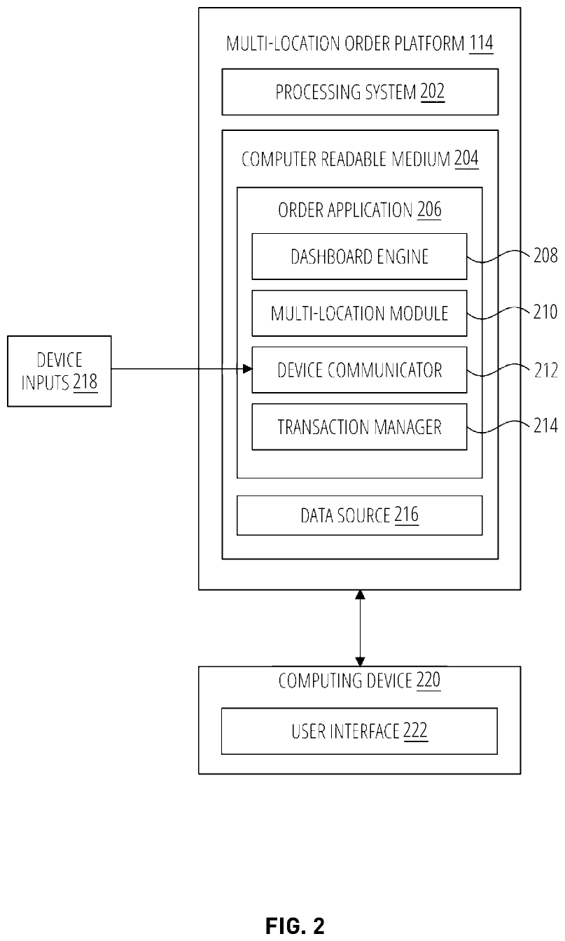

FIG. 2 illustrates an example block diagram of a multi-location order platform according to some aspects of the present disclosure. In general, the system shown in FIG. 2 may include multi-location order platform 114. Multi-location order platform 114 may be implemented within the system shown in FIG. 1, including connectivity to network 102 and associated components described within FIG. 1. In some examples, multi-location order platform 114 may be implemented as shown in FIG. 2 and may be connected to computing device 220. Computing device 220 may be a mobile device (e.g., a smartphone, a tablet, a smart watch, etc.), computer (e.g., laptop, desktop computer, etc.), or another computing apparatus with a display configured to render user interface 222. In some examples, computing device 220 may also be associated with network 102, as described in FIG. 1. For example, computing device 220 may be associated with user device(s) 110 and/or mobile device(s) 108.

In some examples, a user may access multi-location order platform 114 via computing device 220. Computing device 220 may connect to multi-location order platform 114 through a communication network that may include one or more processing devices (e.g., computing devices, mobile devices, servers, databases, etc.) configured to operate together to provide the services of the communication network. The one or more processing devices may operate with a same local network (e.g., such as a local area network, wide area network, distributed processing network, or the like). Computing device 220 may connect to the communication network, and subsequently, multi-location order platform 114, directly or through one or more intermediary networks (e.g., such as the Internet, virtual private networks, etc.).

Multi-location order platform 114 may include an order application 206 executed to perform one or more of the operations described herein. Order application 206 may be stored in a computer readable medium 204 (e.g., memory) and executed on processing system 202 of multi-location order platform 114 or other type of computing system, such as that described below. For example, order application 206 may include instructions that may be executed in an operating system environment, such as Microsoft Windows operating system, Linux operating system, MacOS operating system, or a UNIX operating system environment. By way of example and not limitation, non-transitory computer readable medium 204 comprises computer storage media, such as non-transient storage memory, volatile media, nonvolatile media, removable media, and/or non-removable media implemented in a method or technology for storage of information, such as computer readable instructions, data structures, program modules, or other data.

Order application 206 may also utilize data source 216 of computer readable medium 204 for storage of data and information associated with multi-location order platform 114. For example, order application 206 may store received data or inputs, processing details, and/or output information, and the like, associated with any user account, order history, processed orders, order status, location data, user accounts associated with a location, any combination thereof, or the like, may be stored and accessed by order application 206, computing device 220, and any other component associated with multi-location order platform 114.

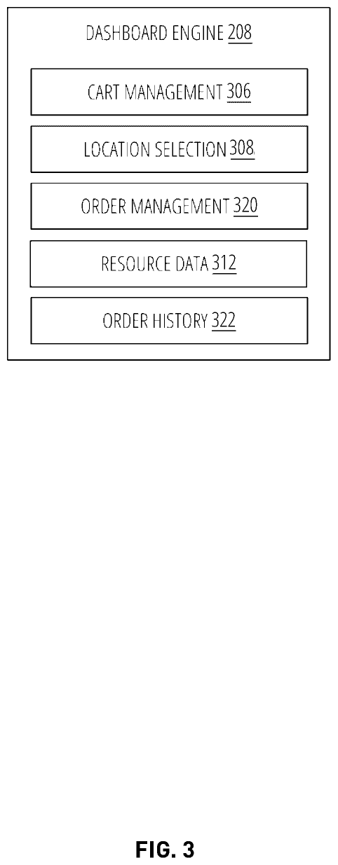

Multi-location order platform and the system described in FIG. 2 includes methodology and components that allow for seamless data flow and order facilitation for one or more sub-accounts associated with a user account. To provide these features, order application 206 may include several components to address the challenges and incorporate such considerations in multi-location switching. For example, order application 206 may include a dashboard engine 208 component for communicating with user interface 222 to provide access to order application 206 to a user of computing device 220 or the computing device itself. FIG. 3 illustrates a block diagram of dashboard engine 208 of multi-location order platform 114 of FIG. 2. The illustrated dashboard engine 208 illustrates a few of the many capabilities, components, and/or features of the dashboard engine 208 of the multi-location order platform. In addition, many of the components of dashboard engine 208 may communicate with or otherwise interact with other components and/or features of multi-location order platform 114. For example, some implementations of dashboard engine 208 may include a location selection component configured to receive input pertaining to a location selection by a computing device and updating a user interface according to the location selection.

Order application 206 may also include multi-location module 210, which may be configured to facilitate a seamless transition from a first user interface to a second user interface according to a change in sub-account received from the user account. Multi-location module 210 may store data associated with one or more sub-accounts, including geographic location, name, address, associated user accounts (e.g., user accounts with access to the sub-account), currency, language, any combination thereof, or the like. This data may be received from computing device 220 via device inputs 218, or the like. In some examples, multi-location module 210 may also receive data from alternative sources, such as Internet browsing cookies, browsing histories, external order data (e.g., from other sub-accounts, such as other sub-accounts associated with the user account or other sub-accounts with similar characteristics, such as location), any combination thereof, or the like.

As an illustrative example, a user, via computing device 220 and/or user interface 222, may input a request to initiate order application 206 at the multi-location order platform 114. Order application 206 may perform one or more security verifications, including, but not limited to, a username and password verification. In some examples, computing device 220 may transmit, via device inputs 218, a request to launch a user interface associated with a first sub-account. Multi-location module 210 may query one or more associated databases for data pertaining to the first sub-account and may output a first user interface to user interface 222. The first user interface may include elements specifically applicable to the first sub-account based on the data pertaining to the first sub-account (e.g., location, name, cuisine type, etc.). The user may generate a digital object (e.g., a virtual cart) that may include one or more digital resources (e.g., items) represented by visual representations on user interface 222. After a duration of time, the user may transmit a second request to launch a user interface associated with a second sub-account. Multi-location module 210 may query computing device 220 for data regarding a user account and/or Internet data, may query one or more associated databases for data pertaining to the second sub-account, and may output a second user interface to user interface 222. The user, using the second user interface, may generate a second digital object that may include one or more digital resources represented by visual representations on user interface 222. Order application 206 may maintain both the digital object and the second digital object (and any other applicable digital objects associated with one or more other sub-accounts) and save them in local memory (e.g., RAM, cache, shared local memory, non-volatile memory, etc.). Thus, the user may return to a “saved” digital object, despite altering the user interface and/or switching sub-accounts.

Transaction manager 214 may be configured to transmit a digital object (e.g., a virtual cart) to a payment processing system for completion of a transaction between the user account and one or more third-party vendors, to create an order. In some examples, the one or more third-party vendors may be associated with multi-location order platform 114. In some examples, the payment processing system may be a component of multi-location order platform 114. Transaction manager 214 may receive payment information from a user account (e.g., credit card information, accounts receivable information, banking information, customer ID numbers, etc.), verify the payment information, and may facilitate a distribution of funds to the one or more third-party vendors (e.g., suppliers, an institution associated with multi-location order platform 114, any combination thereof, or the like). In some examples, transaction manager 214 may transmit one or more notifications to computing device 220 via user interface 222 with a transaction status. The transaction status may be related to the processing state of an order associated with the digital object. In some examples, the notification may be transmitted via email, text message, push notification, pop-up, any combination thereof, or the like. The transaction status may indicate that computing device 220 may modify the order, computing device 220 may not modify the order, a delivery status update, payment details, receipts, any combination thereof, or the like.

In some examples, transaction manager 214 may manage a single transaction associated with a digital object and a sub-account. However, in some examples, transaction manager 214 may facilitate a transaction that may include a plurality of digital objects and respective sub-accounts. In some examples, the transaction that includes a plurality of digital objects may process payment through one payment verification and distribution step, but the digital objects may maintain distinction. For example, a user account may check out multiple virtual carts at once, but the individual virtual carts may ship to different locations based on the associated sub-account.

FIG. 3 illustrates an example block diagram of a dashboard engine of the multi-location order platform according to some aspects of the present disclosure. In general, the system shown in FIG. 3 includes a dashboard engine 208, which may be comprised of at least cart management 306, location selection 308, order management 320, resource data 312, order history 322, and any other components necessary to facilitate the functionality of the multi-location module 210 (as discussed in FIG. 2). The modules and/or components of dashboard engine 208 may work independently or in conjunction to perform the operations of dashboard engine 208.

Cart management 306 may be configured to operate one or more virtual carts associated with one or more sub-accounts of the user account. This may include updating, synchronizing (e.g., updating the cart in real-time when multiple user accounts are editing the virtual cart), saving, providing recommendations, maintaining, any combination thereof, or the like, one or more resources included within the virtual cart and/or the virtual cart itself. Cart management 306 may store (e.g., in a cache, local memory, cloud storage, etc.) instances of the one or more virtual carts such that the user account may access a saved virtual cart at any point. Cart management 306 may save virtual carts automatically (e.g., after a certain time period, after a change has been made, etc.) or the user account may transmit a request to save the virtual cart. For example, cart management 306 may manage a first virtual cart associated with a first sub-account, such that if the user account updates the user interface to be associated with the second sub-account, and the first virtual cart is no longer readily accessible within the user interface, the user account may return to a user interface associated with the first sub-account and the first virtual cart may be accessible as the user account left it (e.g., with the same resources). In some examples, more than one virtual cart may be accessible on a user interface. For example, a user account may maintain access to a first virtual cart (associated with a first sub-account) and a second virtual cart (associated with a second sub-account) on the same user interface.

In some examples, cart management 306 may be configured to operate two or more sub-carts associated with a virtual cart of a sub-account. The two or more sub-carts may be accessible via the virtual cart of the sub-account. The two or more sub-carts may include some or all of the characteristics of the virtual cart (e.g., storing resources, association with the sub-account, association with the user account, association with a particular entity/address/payment method, etc.). The two or more sub-carts may be accessible when the user interface is configured according to the sub-account. In some examples, the user account may add a sub-cart, remove a sub-cart, or edit a sub-cart. The two or more sub-carts may be associated with a particular day, an authorized user associated with the sub-account, a particular event, any combination thereof, or the like.

Location selection 308 may be configured to facilitate the switching from one sub-account to another sub-account. This may include updating one or more resources available within the multi-location module 210, updating the user interface, switching a virtual cart associated with a sub-account to a virtual cart associated with another sub-account, updating payment methods, updating contact information, any combination thereof, or the like. In some examples, location selection 308 may access one or more databases (and/or other third-party sources, such as account data, location data, Internet cookies, local cache, etc.) that may include data pertaining to the one or more sub-accounts associated with the user account. In some examples, the user account may be associated with a sub-account over a duration of access to order application 206. The user account may transmit a request, via a user interface (e.g., user interface 222 of FIG. 2) to change the sub-account associated with the user account of the duration of access (e.g., switch from a first sub-account to a second sub-account). Location selection 308 may receive the request and may execute the request, assuming user account is permitted to access the second sub-account.

To execute the request, location selection 308 may update the user interface displayed on a communication interface associated with the user account (e.g., on computing device 220 of FIG. 2). Location selection 308 may also update a virtual cart accessible via the user interface. The updated user interface and the updated virtual cart may be associated with the second sub-account. Location selection 308 may also update data associated with one or more resources that may be referenced within the user interface (e.g., items that the user account may add to the virtual cart). In some examples, location selection 308 may communicate (e.g., via wired or wireless transmissions) with resource data 312 to generate the updated data associated with one or more resources. Updating the data may include modifying prices, availability, ship time, suppliers, any combination thereof, or the like.

Resource data 312 may be configured to gather, store, and query data from one or more third-party, external, and/or local storage sources to generate information pertaining to one or more resources available on a user interface (e.g., items for sale, suppliers, items that may be added to a virtual cart, etc.). The data may be stored in a database accessible to resource data 312 and/or any other component of order application 206, as described in FIG. 2. The data accessible by resource data 312 may include, but is not limited to, resource pricing (e.g., pricing may be determined by an equation based on a geographic location associated with a sub-account), resource availability (e.g., some resources may not be available according to a geographic location associated with a sub-account, such as seafood), resource ship time, resource supplier (e.g., one resource may be supplied by different suppliers, such as one on the East Coast and one on the West Coast), images and/or representations of the resource, titles, names, weight, size, storage guidelines, instructions, any combination thereof, or the like.

Order management 320 may be configured to modify a submitted order based on requests from the user account. Order management 320 may receive one or more order status updates from a server associated with the multi-location order platform. The order status updates may include, but are not limited to, notifications that resources associated with the order have been shipped, fulfilled, processed, delivered, any combination thereof, or the like. In some examples, the resources associated with an order may be associated with different statuses. For example, Resource A may be “shipped,” while Resource B may be “processed.” The order status updates may be transmitted to the server from one or more suppliers (e.g., shipping warehouses, supply distributors, farmers, any combination thereof, or the like). In some examples, the resources associated with an order may be associated with different suppliers. For example, Resource A may be associated with Supplier A, while Resource B may be associated with Supplier B.

In some examples, the order status and/or the status of a particular resource may be associated with the ability to modify the order and/or resource. For example, if an order has not been shipped yet, then a user account may transmit a request to modify the order (e.g., change quantity, delivery date, contents, etc.). The ability to modify and/or not modify may be transmitted to the user account via one or more notifications (e.g., text message, push notification, email, phone call, a “status” within the user account, etc.).

In some examples, user account may transmit a request to modify an order. Order management 320 may receive the request and determine the resources to be modified by the request. Order management 320 may query, from resource data 312 or another data source, for data pertaining to the resources to be modified, such as the supplier, fulfillment services, terms of purchase, any combination thereof, or the like. Based on this data, order management 320 may transmit a request to a remote computer, server, controller, manager, administrator, network, any combination thereof, or the like, to execute the modification of the order. In some examples, modification of the order and/or resources within the order may not be possible after analyzing the data from resource data 312 or another data source. In such examples, order management 320 may transmit a notification to the user account that may contain an indication of the failure to modify the order and/or resource.

Order history 322 may be configured to maintain a reference to order information of a user account. The order information may include recent orders, recent resources included within an order, frequently ordered resources, recommended resources, any combination thereof, or the like, associated with a user account. In some examples, order history 322 may access a database (e.g., data source 216 as described in FIG. 2) where the order information may be stored in association with the user account. In some examples, location selection 308, cart management 306, resource data 312, and any other components of dashboard engine 208 and/or order application 206 (as described in FIG. 2) may query order history 322 for order information. For example, location selection 308 may query order history 322 for resources that are frequently included in the virtual cart associated with a first sub-account so that location selection 308 may generate a user interface that includes recommended resources. In some examples, recommended resources may be generated using a machine learning algorithm trained to identify trends in ordering in an online marketplace.

In some examples, order history 322 may utilize one or more processors to generate one or more order guides applicable to a sub-account. The order guides may be accessible to the user account and/or additional user accounts with access to the sub-account (e.g., a manager, a buyer, a chef, etc.). The order guides may include one or more resources that may be added to a virtual cart, that may be recommended by order history 322, that may be added to a list by a user account (e.g., a user account adds resources to a “wish list” associated with the sub-account), resources required for a particular recipe, recommended resources to meet a minimum order requirement for a particular supplier/vendor, recommended resources based on resources that have already been added to a virtual cart (e.g., if spoons and knives are in the virtual cart, the order guide may recommend forks), any combination thereof, or the like. In some examples, order history 322 may employ one or more machine-learning models to generate the order guides. The one or more machine-learning models may be trained to generate an order guide based on the order history of a particular sub-account and one or more order histories of similarly situated sub-accounts that may not be affiliated with the user account.

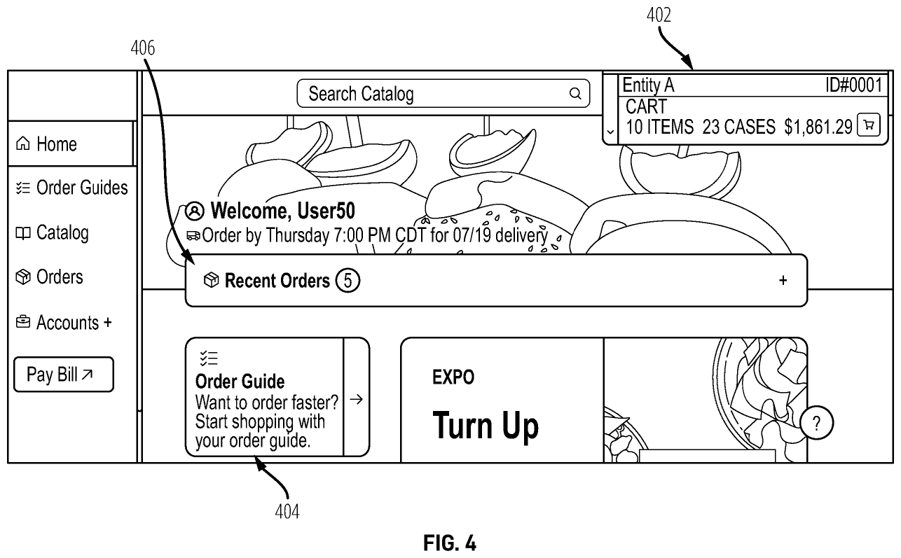

FIG. 4 illustrates an example of a user interface of the multi-location order platform according to some aspects of the present disclosure. As shown in FIG. 4, the user interface may include one or more elements, including elements 402, 404, and 406. Element 402 may be an interactive element in the form of a virtual cart that may display the current sub-account associated with the user interface. Element 402 may also indicate one or more resources within the virtual cart. In the example shown in FIG. 4, the virtual cart may be associated with Entity A, have ten resources in the cart, and may be associated with a value of $1,861.29. Entity A may be a reference to a business, a location, an individual, a nickname (e.g., “Mom's House,” “Lizzie's College Dorm,” “Restaurant A, North Location,” “Jim's Apartment,” “East Warehouse,” etc.), a reference number, any combination thereof, or the like.

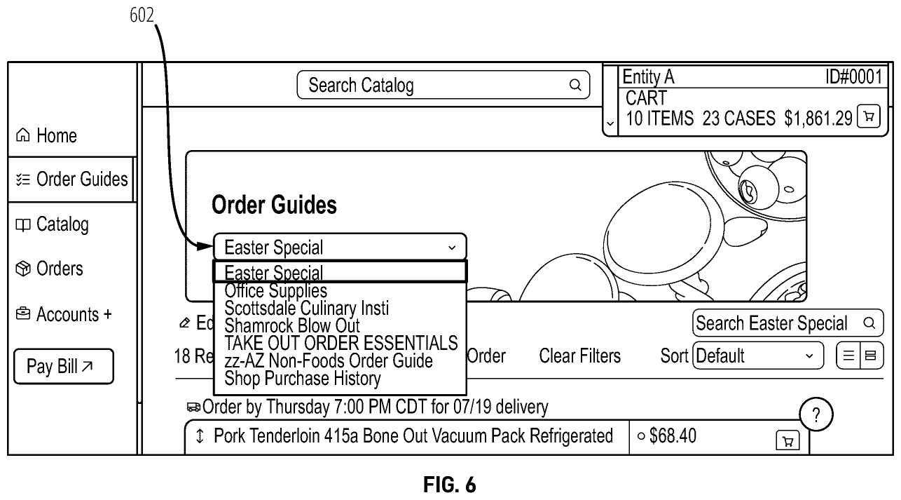

Element 404 may be an interactive element of the user interface that may redirect the user account to a page within the multi-location order platform that shows one or more order guides associated with the sub-account. In this example, element 404 would redirect the user account to a page that shows one or more order guides associated with Entity A. This is described in further detail in FIG. 6.

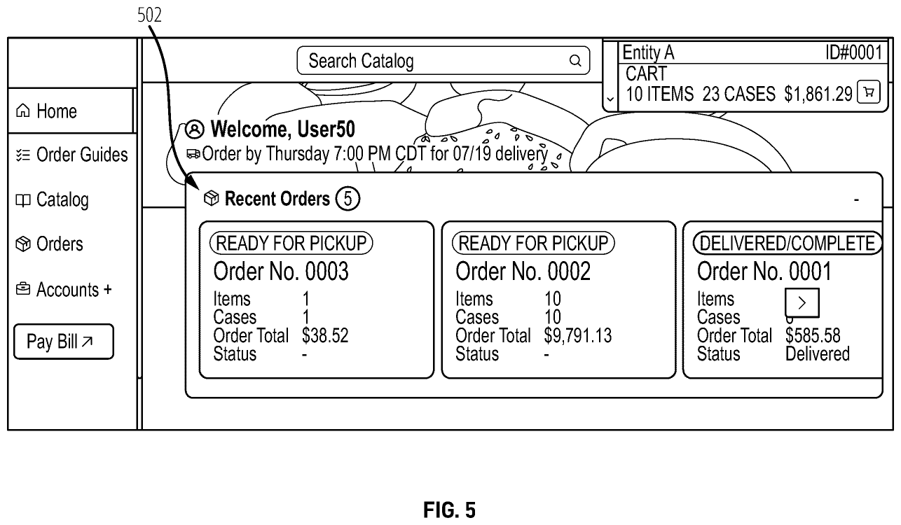

Element 406 may be an interactive element of the user interface that may redirect the user account to a page within the multi-location order platform that shows recent orders associated with the associated sub-account. In this example, element 406 would redirect the user account to a page that shows recent orders of Entity A. This is described in further detail in FIG. 5.

FIG. 5 illustrates an example of a user interface of the multi-location order platform according to some aspects of the present disclosure. As shown in FIG. 5, the user interface may show one or more recent orders associated with a sub-account. This may include order status, order total, order number, fulfillment center/supplier, number of items included in the order, any combination thereof, or the like. Element 502 shows at least two orders associated with Entity A.

FIG. 6 illustrates an example of a user interface of the multi-location order platform according to some aspects of the present disclosure. As shown in FIG. 6, the user interface may show one or more order guides associated with a sub-account. Element 602 may be a drop-down menu that may include a list of one or more user guides associated with Entity A. The user account may select one of the order guides, and the resources included within the selected order guide may appear below in the user interface.

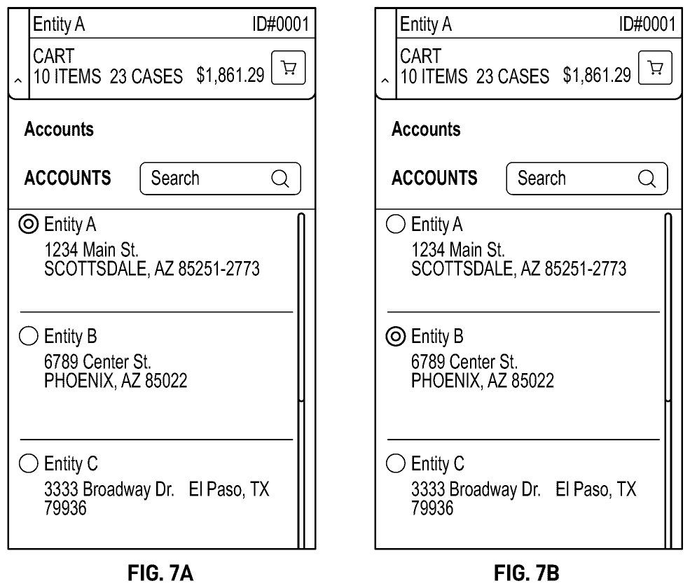

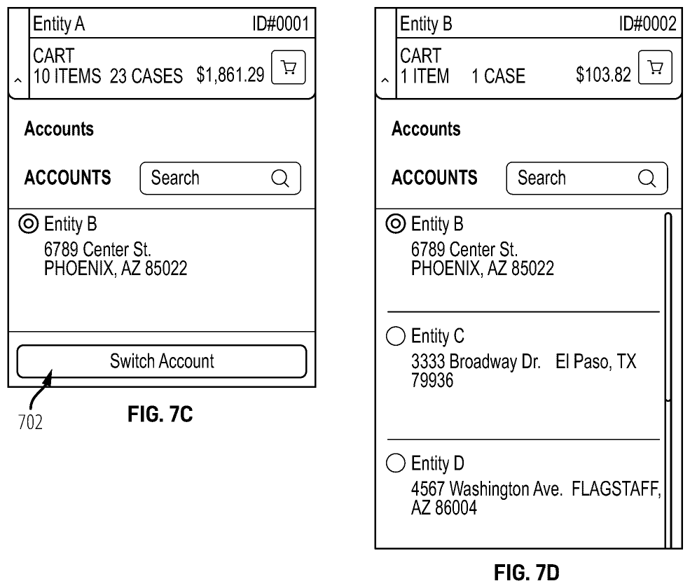

FIG. 7A to FIG. 7D illustrate an example of a user interface of the multi-location order platform according to some aspects of the present disclosure. FIG. 7A to FIG. 7D demonstrate the process for changing the sub-account used to generate and update the user interface. FIG. 7A shows that Entity A is selected as the current sub-account. FIG. 7B shows the user account has generated input to the multi-location order platform indicating a new selection, Entity B. The selection is indicated by a differentiating graphic, such as the selection circle to the left of the sub-account name. As shown in FIG. 7C, the user account may transmit additional input to the multi-location order platform at element 702. The user account may interact with element 702 (e.g., touching it on a touch screen, clicking it with a mouse and mouse cursor, etc.), thereby transmitting a request to switch the sub-account to Entity B. FIG. 7D demonstrates the new sub-account, Entity B, as the “active” sub-account used to generate the current user interface.

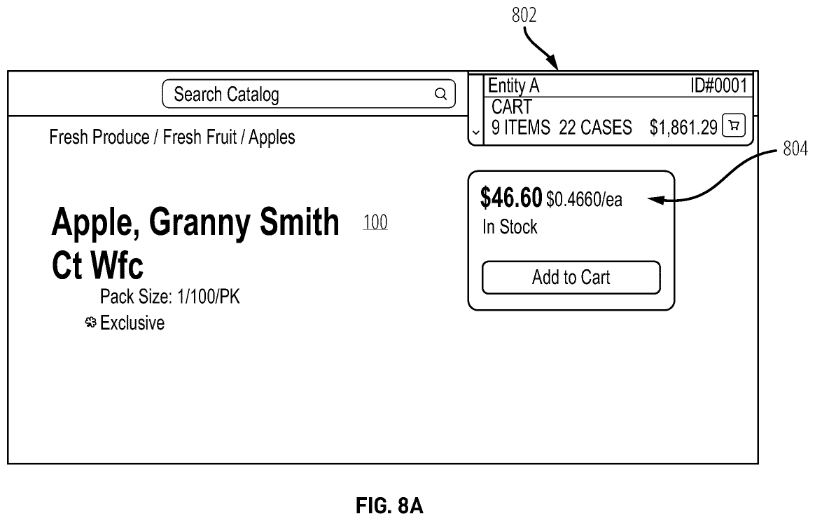

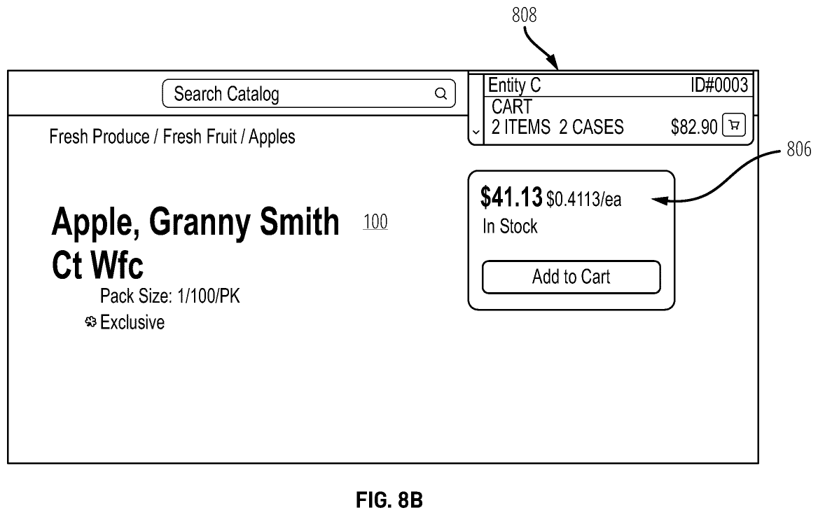

FIG. 8A and FIG. 8B illustrate an example of a user interface of the multi-location order platform according to some aspects of the present disclosure. FIG. 8A describes a page of the multi-location order platform that includes a reference and information pertaining to “Apple, Granny Smith 100 Ct Wfc.” Element 802 indicates that the sub-account associated with the user interface is Entity A. Element 804 indicates a price associated with “Apple, Granny Smith 100 Ct Wfc” based on the sub-account indicated by Element 802. FIG. 8B is similar to FIG. 8A, but the user interface described in 8B is based on Entity C, as shown by element 808. Element 806 of FIG. 8B also indicates a price associated with “Apple, Granny Smith 100 Ct Wfc” based on the sub-account indicated by element 808. Here, element 804 indicates a price of $46.60, while element 806 indicates a price of $41.13. The price difference may depend on one or more variables associated with the sub-account of the user interface, such as a geographic location, taxes, shipping fees, suppliers, etc.

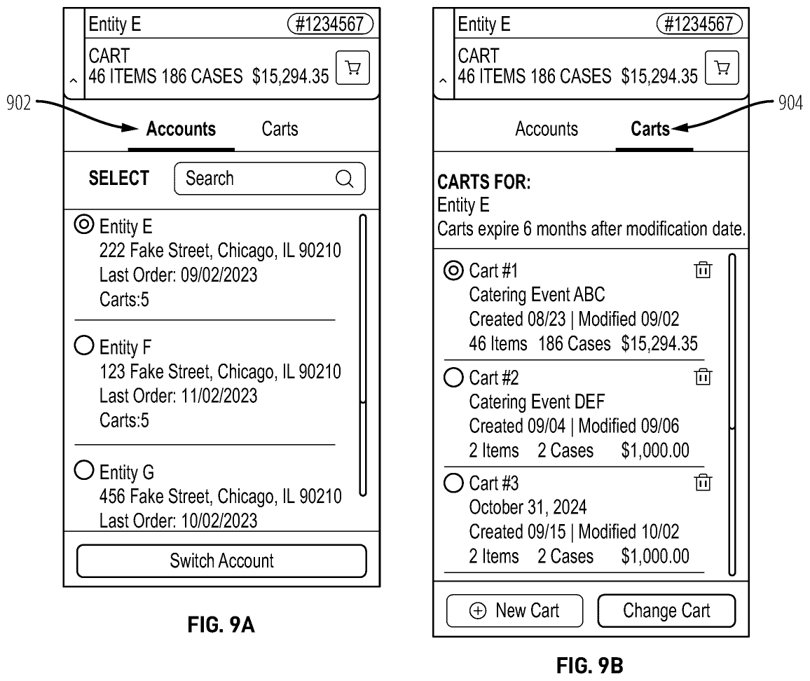

FIG. 9A and FIG. 9B illustrate an example of a user interface of a virtual cart associated with a sub-account that includes two or more sub-carts according to some aspects of the present disclosure. FIG. 9A and FIG. 9B demonstrate an example embodiment and/or modification of the user interface shown in FIGS. 7A-7D. In contrast to FIGS. 7A-7D, FIG. 9A and FIG. 9B show an additional selection element at the top of the virtual cart that allows the user to switch between sub-accounts and sub-carts. Element 902 of FIG. 9A shows that the “account” (e.g., indicating an option to select between sub-accounts) option is active within the virtual cart, indicating that the user may actively switch between sub-accounts associated with the user account. Element 904 of FIG. 9B shows that the “cart” (e.g., indicating an option to select between sub-carts) option is active within the virtual cart, indicating that the user may actively switch between sub-carts associated with the active sub-account shown at the top of the user interface.

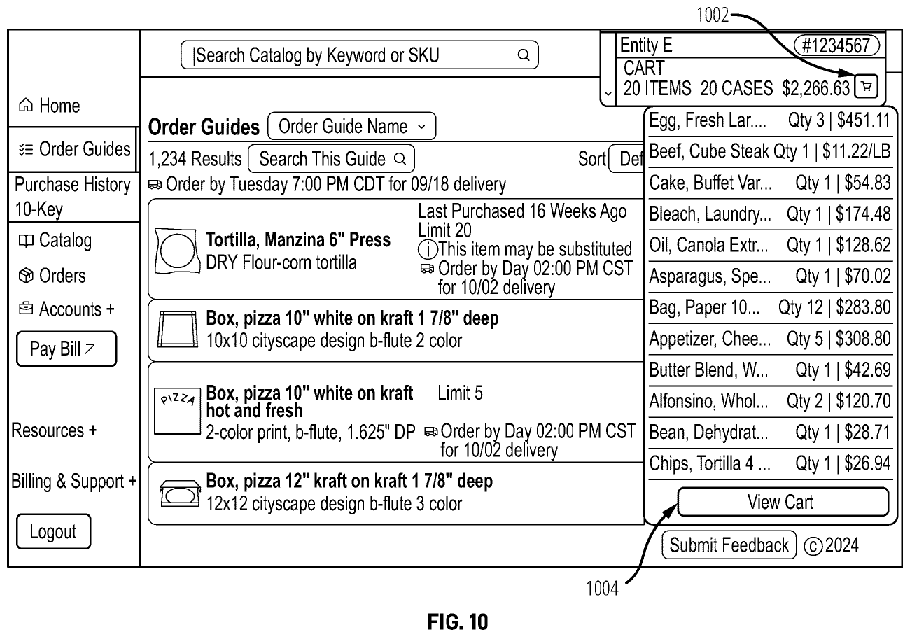

FIG. 10 illustrates an example user interface of a multi-location order platform according to some aspects of the present disclosure. In some examples, the virtual cart within the multi-location order platform may provide a “cart preview,” where a user of a user device may interact with an element of the virtual cart (e.g., element 1002) to result in a pop-up displaying some or all of the resources included within the virtual cart. The interaction from the user of the user device may be a mouse hover (e.g., using a cursor associated with an external mouse, touchpad, or the like to “hover” over an element of the user interface), a click, a touch on a touch screen, input from a keyboard, any combination thereof, or the like. The cart preview may be displayed on the user interface for a set duration of time, until another action occurs (e.g., another click, another pop-up occurs, etc.), when the cursor is removed from the element of the virtual cart, any combination thereof, or the like. In some examples, the user of the user device may scroll (e.g., using a mouse, a touchpad, etc.) through the one or more resources of the virtual cart within the cart preview if the one or more resources are not all visible in the initial presentation of the cart preview. In some examples, the user of the user device may interact with (e.g., click, select, touch, etc.) element 1004, which may redirect the user to a user interface configured to allow the user to edit the resources within the virtual cart (e.g., add resources, edit quantity of resources, remove resources, etc.).

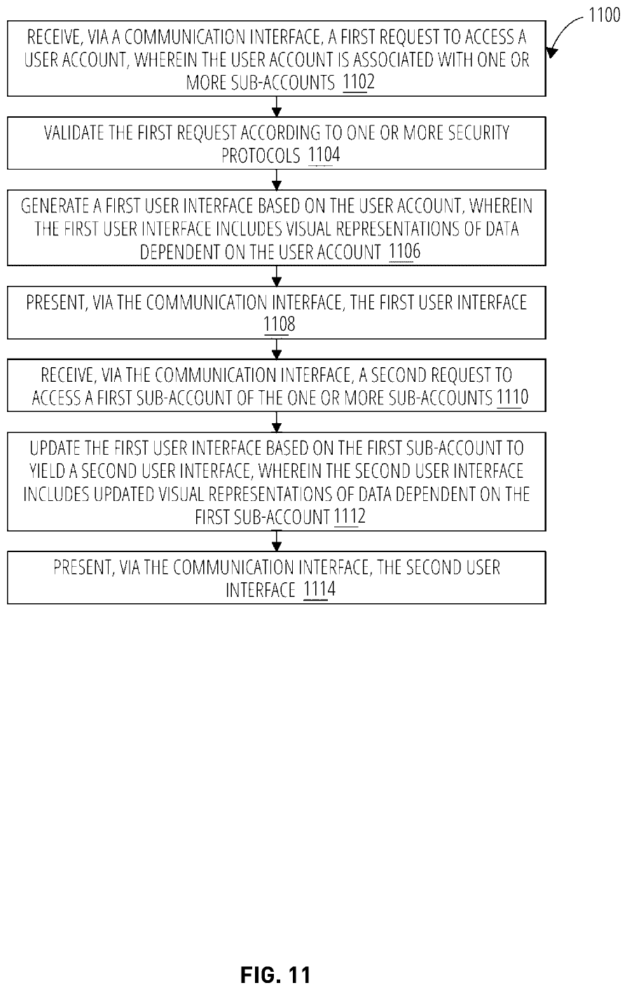

FIG. 11 illustrates an example flowchart for implementing multi-location switching in an online marketplace according to some aspects of the present disclosure. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

According to some examples, the method includes receiving, via a communication interface, a first request to access a user account, wherein the user account is associated with one or more sub-accounts at block 1102. The first request may be transmitted via a user device and may be received by a server associated with a multi-location order platform. In some examples, the multi-location order platform may be access via a shared communication network (e.g., the Internet). In some other examples, the multi-location order platform may be accessed through a cloud storage device, where the first request includes a request to instantiate an instance of the multi-location platform associated with the user device. In some other examples, the multi-location order platform may be locally accessed through an application, program, etc. stored on the user device.

According to some examples, the method includes validating the first request according to one or more security protocols at block 1104. For example, the multi-location order platform may request a username and/or password associated with an account of the multi-location order platform. In some other examples, the multi-location order platform may require additional verification, including, but not limited to, multi-factor authorization, e-mail confirmation, phone number confirmation, security question(s), any combination thereof, or the like.

According to some examples, the method includes generating a first user interface based on the user account, wherein the first user interface includes visual representations of data dependent on the user account at block 1106. The first user interface may include one or more graphical user interfaces (GUIs), which may include images, graphics, logos, text, any combination thereof, or the like. The first user interface may also include a search bar (e.g., for entering a textual search for a resource and/or type of resource), menus (e.g., for browsing different categories of resources), buttons (e.g., for redirecting to a different portion of the multi-location order platform), any combination thereof, or the like.

In some examples, the first user interface may be associated with a sub-account (e.g., the last sub-account accessed by the user account, the sub-account most frequently accessed by the user account, the sub-account with the first alphabetical name of one or more sub-accounts associated with the user account, etc.). In some other examples, the first user interface may request additional input from the user device, such as a selection of a sub-account. In some other examples, the first user interface may proceed with typical operation (e.g., the ability to search for a resource, browse different resources, etc.), with some functionality removed if a sub-account is not identified (e.g., a user account may not “add to cart,” prices may be missing from references to particular resources, etc.).

According to some examples, the method includes presenting, via the communication interface, the first user interface at block 1108. The first user interface may be presented via a communication interface of a user device (e.g., computing device 220 and user interface 222 as described in FIG. 2). The communication interface may be a screen (e.g., a smartphone, a laptop, a desktop, a tablet, a TV, etc.). In some examples, the screen may have touch input capabilities. In some other examples, the screen may be associated with one or more additional input devices, such as a keyboard, mouse, microphone, camera, etc.

According to some examples, the method includes receiving, via the communication interface, a second request to access a first sub-account of the one or more sub-accounts at block 1110. The user account may indicate, through input on the communication interface (e.g., touch on a touch screen, microphone input, mouse click input, keyboard input, etc.), the second request to access the first sub-account. In some examples, the user account may select the first sub-account from a list of one or more sub-accounts accessible to the user account via a drop-down menu associated with a virtual cart.

According to some examples, the method includes updating the first user interface based on the first sub-account to yield a second user interface, wherein the second user interface includes updated visual representations of data dependent on the first sub-account at block 1112. In some examples, the second user interface may include information pertaining to the first sub-account and/or dependent on the first sub-account. For example, the second user interface may be generated based on a geographic location associated with the first sub-account. Based on the geographic location, prices (e.g., due to supplier changes, shipping charges, etc.), availability, shipping times, etc. may change from the first user interface to the second user interface.

According to some examples, the method includes presenting, via the communication interface, the second user interface at block 1114. The second user interface may be presented via the communication interface of the user device.

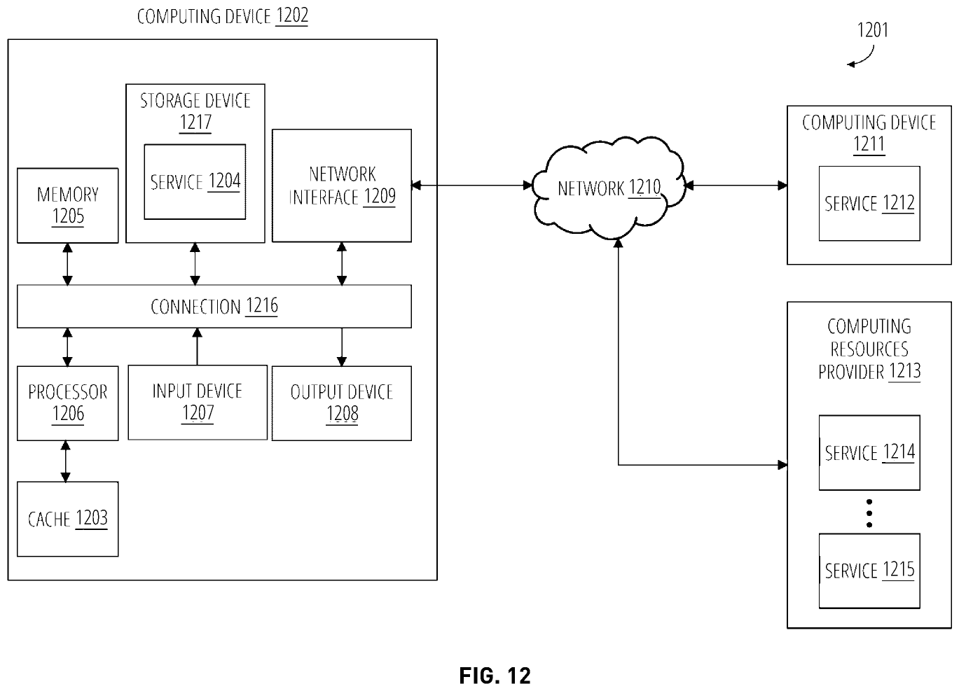

FIG. 12 illustrates an example computing device capable of executing the integrated service and any other associated components according to some aspects of the present disclosure. This may include a computing system architecture 1201, including various components in electrical communication with each other. The example computing system architecture 1201 illustrated in FIG. 12 includes a computing device 1202, which has various components in electrical communication with each other using a connection 1216, such as a bus, in accordance with some implementations. The example computing system architecture 1201 includes a processor 1206 that is in electrical communication with various system components, using the connection 1216, and including the system memory 1205. In some embodiments, the system memory 1205 includes read-only memory (ROM), random-access memory (RAM), and other such memory technologies including, but not limited to, those described herein. In some embodiments, the example computing system architecture 1201 includes a cache 1203 of high-speed memory connected directly with, in close proximity to, or integrated as part of the processor 1206. The system architecture 1201 can copy data from the memory 1205 and/or the storage device 1217 to the cache 1203 for quick access by the processor 1206. In this way, the cache 1203 can provide a performance boost that decreases or eliminates processor delays in the processor 1206 due to waiting for data. Using modules, methods, and services such as those described herein, the processor 1206 can be configured to perform various actions. In some embodiments, the cache 1203 may include multiple types of cache including, for example, level one (L1) and level two (L2) cache. The memory 1205 may be referred to herein as system memory or computer system memory. The memory 1205 may include, at various times, elements of an operating system, one or more applications, data associated with the operating system or the one or more applications, or other such data associated with the computing device 1202.

Other system memory 1205 can be available for use as well. The memory 1205 can include multiple different types of memory with different performance characteristics. The processor 1206 can include any general-purpose processor and one or more hardware or software services, such as service 1204 stored in storage device 1217, configured to control the processor 1206 as well as a special-purpose processor where software instructions are incorporated into the actual processor design. The processor 1206 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1206 can be a microprocessor, a microcontroller, a digital signal processor (“DSP”), or a combination of these and/or other types of processors. In some embodiments, the processor 1206 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1201, an input device 616 can represent any number of input mechanisms, such as a microphone for speech, a touch-sensitive screen for gesture or graphical input, keyboard, mouse, motion input, pen, and other such input devices. An output device 1208 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1201. In some embodiments, the input device 1207 and/or the output device 1208 can be coupled to the computing device 1202 using a remote connection device such as, for example, a communication interface such as the network interface 1209 described herein. In such embodiments, the communication interface can govern and manage the input and output received from the attached input device 1207 and/or output device 1208. As may be contemplated, there is no restriction on operating on any particular hardware arrangement and accordingly the basic features here may easily be substituted for other hardware, software, or firmware arrangements as they are developed.

In some embodiments, the storage device 1217 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1217 can include hardware and/or software services such as service 1204 that can control or configure the processor 1206 to perform one or more functions including, but not limited to, the methods, processes, functions, systems, and services described herein in various embodiments. In some embodiments, the hardware or software services can be implemented as modules. As illustrated in example computing system architecture 1201, the storage device 1217 can be connected to other parts of the computing device 1202 using the system connection 1216. In some embodiments, a hardware service or hardware module such as service 1204, that performs a function can include a software component stored in a non-transitory computer-readable medium that, in connection with the necessary hardware components, such as the processor 1206, connection 1216, cache 1203, storage device 1217, memory 1205, input device 1207, output device 1208, and so forth, can carry out the functions such as those described herein.

The disclosed systems and service of a multi-location order platform (e.g., multi-location order platform 114 described herein at least in connection with FIG. 1) can be performed using a computing system such as the example computing system illustrated in FIG. 6, using one or more components of the example computing system architecture 1201. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for facilitating ordering procedures for multiple sub-accounts (e.g., multi-location order platform 114 described herein at least in connection with FIG. 1) described herein by, for example, executing code using a processor such as processor 1206 wherein the code is stored in memory such as memory 1205 as described herein. One or more of a user device, a provider server or system, a database system, or other such devices, services, or systems may include some or all of the components of the computing system such as the example computing system illustrated in FIG. 12, using one or more components of the example computing system architecture 1201 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1213. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1206 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1205 can be coupled to the processor 1206 by, for example, a connector such as connection 1216, or a bus. As used herein, a connector or bus such as connection 1216 is a communications system that transfers data between components within the computing device 1202 and may, in some embodiments, be used to transfer data between computing devices. The connection 1216 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1205 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connection 1216 (or bus) can also couple the processor 1206 to the storage device 1217, which may include non-volatile memory or storage, and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1217. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1216 can also couple the processor 1206 to a network interface device such as the network interface 1209. The interface can include one or more of a modem or other such network interfaces including, but not limited to those described herein. It will be appreciated that the network interface 1209 may be considered to be part of the computing device 1202 or may be separate from the computing device 1202. The network interface 1209 can include one or more of an analog modem, Integrated Services Digital Network (ISDN) modem, cable modem, token ring interface, satellite transmission interface, or other interfaces for coupling a computer system to other computer systems. In some embodiments, the network interface 1209 can include one or more input and/or output (I/O) devices. The I/O devices can include, by way of example but not limitation, input devices such as input device 1207 and/or output devices such as output device 1208. For example, the network interface 1209 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., Vx Works®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1202 can be connected to one or more additional computing devices such as computing device 1211 via a network 1210 using a connection such as the network interface 1209. In such embodiments, the computing device 1211 may execute one or more services 1212 to perform one or more functions under the control of, or on behalf of, programs and/or services operating on computing device 1202. In some embodiments, a computing device such as computing device 1211 may include one or more of the types of components as described in connection with computing device 1202 including, but not limited to, a processor such as processor 1206, a connection such as connection 1216, a cache such as cache 1203, a storage device such as storage device 1217, memory such as memory 1205, an input device such as input device 1207, and an output device such as output device 1208. In such embodiments, the computing device 1211 can carry out the functions such as those described herein in connection with computing device 1202. In some embodiments, the computing device 1202 can be connected to a plurality of computing devices such as computing device 1211, each of which may also be connected to a plurality of computing devices such as computing device 1211. Such an embodiment may be referred to herein as a distributed computing environment.

The network 1210 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1210 can be wired connections, wireless connections, or combinations thereof. Communications via the network 1210 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1210, within the computing device 1202, within the computing device 1211, or within the computing resources provider 1213 can include information, which also may be referred to herein as content. The information may include text, graphics, audio, video, haptics, and/or any other information that can be provided to a user of the computing device such as the computing device 1202. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1202 and presented to a user of the computing device 1202 using forms that are perceptible via sight, sound, smell, taste, touch, or other such mechanisms. In some embodiments, communications over the network 1210 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1202 and/or the computing device 1211 can be connected to a computing resources provider 1213 via the network 1210 using a network interface such as those described herein (e.g., network interface 1209). In such embodiments, one or more systems (e.g., service 1214 and service 1215) hosted within the computing resources provider 1213 (also referred to herein as within “a computing resources provider environment”) may execute one or more services to perform one or more functions under the control of, or on behalf of, programs and/or services operating on computing device 1202 and/or computing device 1211. Systems such as service 1214 and service 1215 may include one or more computing devices such as those described herein to execute computer code to perform the one or more functions under the control of, or on behalf of, programs and/or services operating on computing device 1202 and/or computing device 1211.

For example, the computing resources provider 1213 may provide a service, operating on service 1214 to store data for the computing device 1202 when, for example, the amount of data that the computing device 1202 exceeds the capacity of storage device 1217. In another example, the computing resources provider 1213 may provide a service to first instantiate a virtual machine (VM) on service 1215, use that VM to access the data stored on service 1215, perform one or more operations on that data, and provide a result of those one or more operations to the computing device 1202. Such operations (e.g., data storage and VM instantiation) may be referred to herein as operating “in the cloud,” “within a cloud computing environment,” or “within a hosted virtual machine environment,” and the computing resources provider 1213 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1213 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1214 and service 1215 may implement versions of various services (e.g., the service 1204 or the service 1212) on behalf of, or under the control of, computing device 1202 and/or computing device 1211. Such implemented versions of various services may involve one or more virtualization techniques so that, for example, it may appear to a user of computing device 1202 that the service 1204 is executing on the computing device 1202 when the service is executing on, for example, service 1214. As may also be contemplated, the various services operating within the computing resources provider 1213 environment may be distributed among various systems within the environment as well as partially distributed onto computing device 1211 and/or computing device 1202.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1202) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory, or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the method 900 of FIG. 11). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computing device 1202.

In general, the routines executed to implement the implementations of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A system for implementing multi-location switching in an online marketplace, comprising:
a communication interface of a user device;
one or more processors; and
a non-transitory computer-readable storage medium containing instructions which, when executed by the one or more processors, cause the one or more processors to:
receive, via the communication interface, a first request to access a user account, wherein the user account is associated with one or more sub-accounts;
validate the first request according to one or more security protocols;
generate a first user interface based on the user account, wherein the first user interface includes visual representations of data dependent on the user account;
present, via the communication interface, the first user interface;
receive, via the communication interface, a second request to access a first sub-account of the one or more sub-accounts;
retrieve, from a database of account and sub-account information, data associated with the first sub-account, the data identifying at least a geographic location of the first sub-account; and
update the first user interface based on the retrieved data associated with the first sub-account to yield a second user interface, wherein the second user interface includes updated visual representations of location-dependent data based on the geographic location of the first sub-account.

2. The system of claim 1, the instructions further causing the one or more processors to:
receive, via the second user interface of the communication interface, a third request to maintain a first digital object, wherein the first digital object is associated with the first sub-account;
receive, via the communication interface, user input indicating that the first digital object should be updated to include a first resource; and
update the first digital object to include the first resource.

3. The system of claim 2, wherein the first digital object includes at least two digital sub-objects associated with respective resources, the instructions further causing the one or more processors to:
receive, via the second user interface of the communication interface, a fourth request to maintain a digital sub-object of the at least two digital sub-objects, wherein the digital sub-object is associated with the first digital object and the first sub-account;
receive, via the communication interface, user input indicating that the digital sub-object should be updated to include a second resource; and
update the digital sub-object to include the second resource.

4. The system of claim 3, the instructions further causing the one or more processors to:
receive, via the communication interface, a transaction request to complete a transaction associated with the digital sub-object.

5. The system of claim 1, the instructions further causing the one or more processors to:
receive, via the communication interface, a fifth request to access a second sub-account of the one or more sub-accounts;
update the second user interface based on the second sub-account to yield a third user interface, wherein the third user interface includes updated visual representations of data dependent on the second sub-account; and
present, via the communication interface, the third user interface.

6. The system of claim 5, the instructions further causing the one or more processors to:
receive, via the third user interface of the communication interface, a sixth request to maintain a second digital object, wherein the second digital object is associated with the second sub-account;
receive, via the communication interface, user input indicating that the second digital object should be updated to include a second resource; and
update the second digital object to include the second resource.

7. The system of claim 1, wherein the one or more sub-accounts are associated with a respective digital object accessible via a user interface.

8. The system of claim 1, the instructions further causing the one or more processors to:
receive, via the communication interface, a transaction request to complete a transaction associated with a digital object of the first sub-account.

9. The system of claim 8, the instructions further causing the one or more processors to:
complete the transaction associated with the digital object of the first sub-account; and
transmit the transaction to one or more remote servers for fulfillment, wherein the transaction includes data associated with the digital object and the first sub-account, and wherein when received by the one or more remote servers, the one or more remote servers begin servicing the transaction.

10. The system of claim 9, the instructions further causing the one or more processors to:
send a notification to the user account, wherein the notification includes an indication that the transaction may be modified.

11. The system of claim 9, the instructions further causing the one or more processors to:
send a notification to the user account, wherein the notification includes an indication that the one or more remote servers have completed servicing the transaction and the transaction can no longer be modified.

12. The system of claim 1, wherein the one or more security protocols include verifying a user identifier has permission to access the one or more sub-accounts.

13. The system of claim 1, wherein at least one sub-account of the one or more sub-accounts are associated with two or more digital objects accessible via a user interface.

14. A computer-implemented method, comprising:
receiving, via a communication interface, a first request to access a user account, wherein the user account is associated with one or more sub-accounts;
validating the first request according to one or more security protocols;
generating a first user interface based on the user account, wherein the first user interface includes visual representations of data dependent on the user account;
presenting, via the communication interface, the first user interface;
receiving, via the communication interface, a second request to access a first sub-account of the one or more sub-accounts;
retrieving, from a database of account and sub-account information, data associated with the first sub-account, the data identifying at least a geographic location of the first sub-account; and
updating the first user interface based on the retrieved data associated with the first sub-account to yield a second user interface, wherein the second user interface includes updated visual representations of location-dependent data based on the geographic location of the first sub-account.

15. The computer-implemented method of claim 14, further comprising:
receiving, via the second user interface of the communication interface, a third request to maintain a first digital object, wherein the first digital object is associated with the first sub-account;
receiving, via the communication interface, user input indicating that the first digital object should be updated to include a first resource; and
updating the first digital object to include the first resource.

16. The computer-implemented method of claim 15, wherein the first digital object includes at least two digital sub-objects associated with respective resources, further comprising:
receiving, via the second user interface of the communication interface, a fourth request to maintain a digital sub-object, wherein the digital sub-object is associated with the first digital object and the first sub-account;
receiving, via the communication interface, user input indicating that the digital sub-object should be updated to include a second resource; and
updating the digital sub-object to include the second resource.

17. The computer-implemented method of claim 16, further comprising:
receiving, via the communication interface, a transaction request to complete a transaction associated with the digital sub-object.

18. The computer-implemented method of claim 14, further comprising:
receiving, via the communication interface, a fifth request to access a second sub-account of the one or more sub-accounts;
updating the second user interface based on the second sub-account to yield a third user interface, wherein the third user interface includes updated visual representations of data dependent on the second sub-account; and
presenting, via the communication interface, the third user interface.

19. The computer-implemented method of claim 18, further comprising:
receiving, via the third user interface of the communication interface, a sixth request to maintain a second digital object, wherein the second digital object is associated with the second sub-account;
receiving, via the communication interface, user input indicating that the second digital object should be updated to include a second resource; and
updating the second digital object to include the second resource.

20. A non-transitory, computer-readable medium storing instructions that, when executed by one or more processors, cause the one or more processors to:
receive, via the communication interface, a first request to access a user account, wherein the user account is associated with one or more sub-accounts;
validate the first request according to one or more security protocols;
generate a first user interface based on the user account, wherein the first user interface includes visual representations of data dependent on the user account;
present, via the communication interface, the first user interface;
receive, via the communication interface, a second request to access a first sub-account of the one or more sub-accounts;
retrieve, from a database of account and sub-account information, data associated with the first sub-account, the data identifying at least a geographic location of the first sub-account; and
update the first user interface based on the retrieved data associated with the first sub-account to yield a second user interface, wherein the second user interface includes updated visual representations of location-dependent data based on the geographic location of the first sub-account.
